(19) United States
(12) Patent Application Publication
(10) Pub. No.: US 2009/0072657 A1
(43) Pub. Date: Mar. 19, 2009

(54) ELECTRIC MOTOR AND FUEL PUMP HAVING THE SAME

(75) Inventor: Kiyonori Moroto, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/209,549

(22) Filed: Sep. 12, 2008

(30) Foreign Application Priority Data
Sep. 19, 2007 (JP) 2007-242739

(51) Int. Cl. H02K 1/26

(52) U.S. Cl. 310/265

(57) ABSTRACT

A permanent magnet has magnetic poles being circumferentially different from each other. An armature is rotatable at a radially inside of the permanent magnet and has a laminated core and a coil. The laminated core includes magnetic plates laminated in an axial direction so as to interpose an insulating layer. The magnetic plates include end magnetic plates located at most distant ends. At least one of the end magnetic plates has an outer circumferential side provided with a collar, which extends in the rotation axis direction so as to be opposed to pole faces of the permanent magnet. The at least one of the end magnetic plates has a thickness t, and the collar has a length h. The thickness t and the length h have a relationship of h/t≦10.

### CROSS REFERENCE TO RELATED APPLICATIONS

This application is based on and incorporates herein by reference Japanese Patent Application No. 2007-242739 filed on Sep. 19, 2007.

### FIELD OF THE INVENTION

The present invention relates to an electric motor and a fuel pump having the electric motor.

### BACKGROUND OF THE INVENTION

For example, JP-A-2001-352731 discloses an electric motor having permanent magnets, which forms magnetic poles being mutually different in polarity in a circumferential direction, and an armature, which is arranged at radially inner side of the permanent magnets in a freely rotatable manner. The motor further has a laminated core, which is configured by laminating multiple magnetic plates in an axial direction while an insulating layer for suppressing electric conduction is interposed between the magnetic plates. A coil is wound on the laminated core.

A collar is formed at a radially outer side of each of end magnetic plates provided at the most distant ends in a rotation axis direction among the laminated magnetic plates. The collar extends in the rotation axis direction so as to face pole faces of the permanent magnets. According to the present configuration, the area of the laminated core facing the pole faces of the permanent magnets is increased. Therefore, an amount of magnetic flux in the laminated core can be increased without increasing the axial length thereof.

In the JP-A-2001-352731, the insulating layer for suppressing eddy-current loss is provided between the magnetic plates adjacent to each other. Therefore, magnetic flux entering each magnetic plate hardly flows in the rotation axis direction. That is, most of magnetic flux flows in a radial direction.

In the present structure, in which the end magnetic plate has the collar at the radially outer side of the magnetic plate, leakage flux from the permanent magnets can be decreased. However, magnetic flux concentrates at a root region of the collar. Accordingly, magnetic resistance increases in the root region, and consequently, the amount of magnetic flux in the laminated core cannot be sufficiently increased, even through the collar is formed on the end magnetic plate. As a result, torque cannot be effectively increased.

### SUMMARY OF THE INVENTION

In view of the foregoing and other problems, it is an object of the present invention to produce an electric motor having a laminated core configured to increase an amount of magnetic flux therein so as to enhance generated torque therefrom.

According to one aspect of the present invention, an electric motor comprises a permanent magnet having a plurality of magnetic poles, which is circumferentially different from each other. The electric motor further comprises an armature rotatable at a radially inside of the permanent magnet and having a laminated core and a coil, the laminated core including a plurality of magnetic plates, which is laminated in an axial direction so as to interpose an insulating layer for suppressing electrical conduction, the coil being wound on the laminated core. The plurality of magnetic plates includes end magnetic plates located at most distant ends in a rotation axis direction. At least one of the end magnetic plates has an outer circumferential side provided with a collar, which extends in the rotation axis direction so as to be opposed to pole faces of the permanent magnet. The at least one of the end magnetic plates has a thickness t. The collar has a length h. The thickness t and the length h have a relationship of h/t≦10.

According to another aspect of the present invention, an electric motor comprises a permanent magnet having a plurality of magnetic poles, which is circumferentially different from each other. The electric motor further comprises an armature rotatable at a radially inside of the permanent magnet and having a laminated core and a coil, the laminated core including a plurality of magnetic plates, which is laminated in an axial direction so as to interpose an insulating layer for suppressing electrical conduction, the coil being wound on the laminated core. The insulating layer is formed on at least one of two of the magnetic plates, which are adjacent to each other. The plurality of magnetic plates includes end magnetic plates located at most distant ends in a rotation axis direction. At least one of the end magnetic plates has an outer circumferential side provided with a collar, which extends in the rotation axis direction so as to be opposed to pole faces of the permanent magnet. The insulating layer is not formed on at least one of the end magnetic plates.

According to another aspect of the present invention, an electric motor comprises a permanent magnet having a plurality of magnetic poles, which is circumferentially different from each other. The electric motor further comprises an armature rotatable at a radially inside of the permanent magnet and having a laminated core and a coil, the laminated core including a plurality of magnetic plates, which is laminated in an axial direction so as to interpose an insulating layer for suppressing electrical conduction, the coil being wound on the laminated core. The insulating layer is formed on at least one of two of the magnetic plates, which are adjacent to each other. The plurality of magnetic plates includes end magnetic plates located at most distant ends in a rotation axis direction. At least one of the end magnetic plates has an outer circumferential side provided with a collar, which extends in the rotation axis direction so as to be opposed to pole faces of the permanent magnet. The at least one of the end magnetic plates has a thickness t. The collar has a length h. The thickness t and the length h have a relationship of h/t≦10. The insulating layer is not formed on at least one of the end magnetic plates.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing a fuel pump according to a first embodiment;

FIG. 2 is a perspective view showing an armature of the fuel pump before being wound with a coil;

FIG. 3 is a perspective view showing the armature after being wound with the coil, the armature being not provided with a commutator;

FIG. 4 is a perspective view showing the armature after being wound with the coil and being provided with the commutator;

FIG. 5 is a sectional view showing the armature;

FIG. 6 is a sectional view showing a laminated core of the armature; and

FIG. 7 is a sectional view showing a laminated core of an armature of an electric motor provided in a fuel pump according to a second embodiment.

### DETAILED DESCRIPTION OF PREFERRED EMBODIMENTS

### First Embodiment

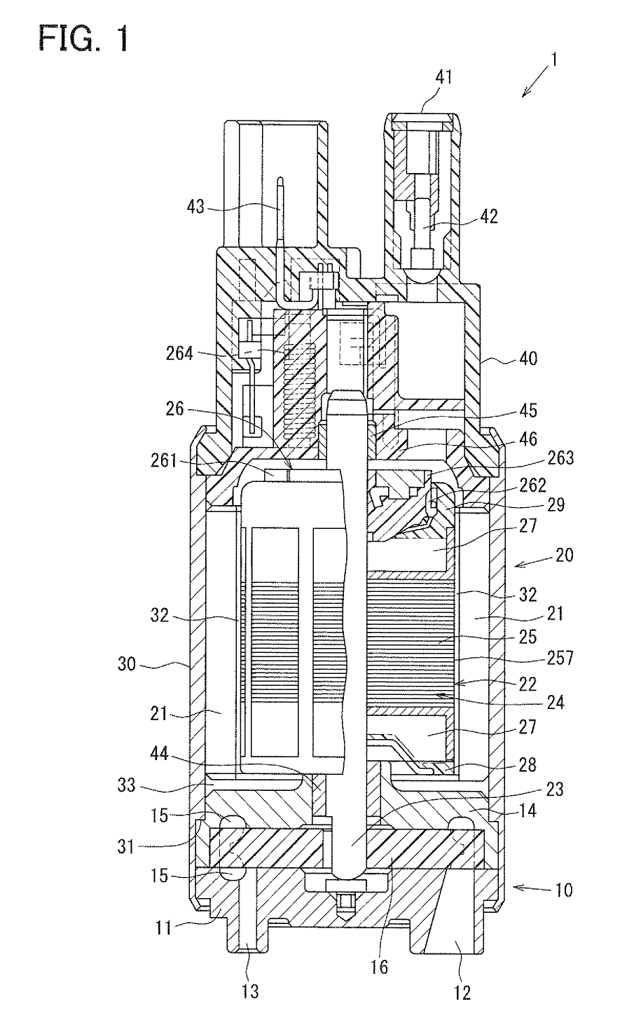

FIG. 1 shows a fuel pump according to the first embodiment. A fuel pump 1 is an in-tank turbine pump to be accommodated in a not-shown fuel tank of a two-wheeled or four-wheeled vehicle or the like.

The fuel pump 1 has a pump portion 10, and a motor portion 20 for driving the pump portion 10. A housing 30 serves as a housing of the pump portion 10 and a housing of the motor portion 20. The housing 30 is caulked with an end cover 40 and a pump cover 11 respectively at both ends in a rotation axis direction. The housing 30 is caulked with the pump cover 11, thereby a pump case 14 is clamped between the pump cover 11 and a stepped portion 31.

The pump portion 10 includes a turbine pump having the pump cover 11, the pump case 14, and an impeller 16. The pump cover 11 and the pump case 14 accommodate the impeller 16 in a freely rotatable manner. The pump cover 11 has a suction port 12 for drawing fuel into a pump passage 15. The pump passage 15 is formed in a C shape between the pump cover 11, the pump case 14, and the impeller 16.

Multiple vane grooves are formed in a rotational direction on an outer circumferential edge of the impeller 16 being in a disk shape. When the impeller 16 rotates together with a shaft 23 in conjunction with rotation of an armature 22, outflow and inflow of fuel are repeated from one vane groove at the front side in the rotational direction to another vane groove at the back side in the rotational direction. Thereby, the fuel is swirled and pressurized in the pump passage 15. An air vent hole 13 is provided in the pump cover 11 for exhausting air contained in fuel in the pump passage 15 to the outside of the fuel pump 1.

Fuel drawn from the suction port 12 by rotation of the impeller 16 is pressurized through the pump passage 15 by rotation of the impeller 16, and the pressurized fuel is pressure-fed to the motor portion 20 from a discharge port (not-shown) provided in the pump case 14. The fuel pressure-fed to the motor portion 20 passes through a fuel passage 32 between permanent magnets 21 and the armature 22, then the fuel is supplied to an engine as a fuel consumption unit from a discharge port 41 provided in the end cover 40. A check valve 42 is accommodated in the discharge port 41, which restricts backflow of fuel discharged from the discharge port 41.

The motor portion 20 is configured by the permanent magnets 21, the armature 22, a commutator 26, and the like. Each of the permanent magnets 21 is, for example, a ferrite magnet, and arcuately formed. Two permanent magnets 21 are circumferentially attached to an inner circumferential wall of the housing 30. The permanent magnets 21 form magnetic poles being mutually different in polarity in a circumferential direction on surfaces facing the armature 22 at the radially inner side of the permanent magnets 21.

The armature 22 is arranged at the radially inner side of the permanent magnets 21. The armature 22 is configured by a laminated core 24, which is formed by laminating magnetic plates 25 in a rotation axis direction, and a coil 27 wound on pole cores of the laminated core 24. An insulating layer 257 for suppressing electric conduction is provided between the magnetic plates 25 adjacent to each other. In FIG. 1, the space shown by a two-dot chain line at either end in the rotation axis direction of the armature 22 is wound with the coil 27. A structure of the laminated core 24 is described later in detail.

As shown in FIG. 1, the shaft 23 being a rotation axis of the armature 22 is supported by bearings 44 and 45 at either end in the rotation axis direction. The bearings 44 and 45 are respectively supported by the pump case 14 and a bearing holder 46.

The commutator 26 is formed in a disk shape, and assembled to an end of the armature 22 in the rotation axis direction at a side opposite to a side of the impeller 16. The commutator 26 has multiple segments 261 arranged in the rotation direction. Each of the segments 261 is formed of, for example, carbon, and electrically connected to the coil 27 through terminals 262. The segments 261 are electrically isolated from one another by a space and an insulating resin material 263.

A gap is formed between the commutator 26 and an end in the rotation axis direction of the coil 27 at the side of the commutator 26, and the gap is filled with an insulating resin material 29. An end in the rotation axis direction of the coil 27 at the side of the pump portion 10 is covered with an insulating resin material 28. The present structure can reduce rotational resistance of the armature 22 when rotating in fuel, and can suppress entering of a foreign substance into the armature 22.

A pump terminal 43 is pressed into the end cover 40. A drive current is supplied from the pump terminal 43 into the coil 27 of the armature 22 through a brush (not-shown) and the commutator 26. End faces of the segments 261 at the opposite to the armature 22 in a rotation axis direction, sequentially slide on the brush, thereby the drive current to be supplied into the coil 27 is commutated.

A chalk coil 264 is connected in series with the brush, and reduces an electric noise generated when the segments 261 of the commutator 26 sequentially slide on the brush.

As shown in FIG. 1, when the impeller 16 is rotated by the motor portion 20, fuel is drawn from the fuel tank into the pump passage 15 via the suction port 12. Fuel flowing into the pump passage 15 is exerted with kinetic energy caused by rotation of the impeller 16 and thus is pressurized, and the fuel is discharged into a fuel chamber 33 of the motor portion 20 from a not-shown discharge port. The fuel sent into the fuel chamber 33 is discharged to the outside of the fuel pump 1 from the discharge port 41 via the fuel passage 32.

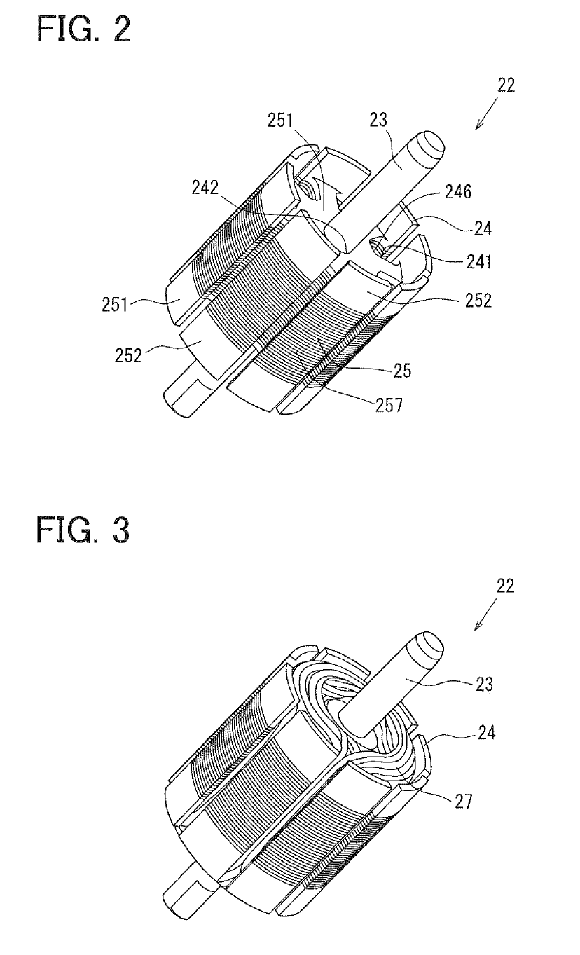

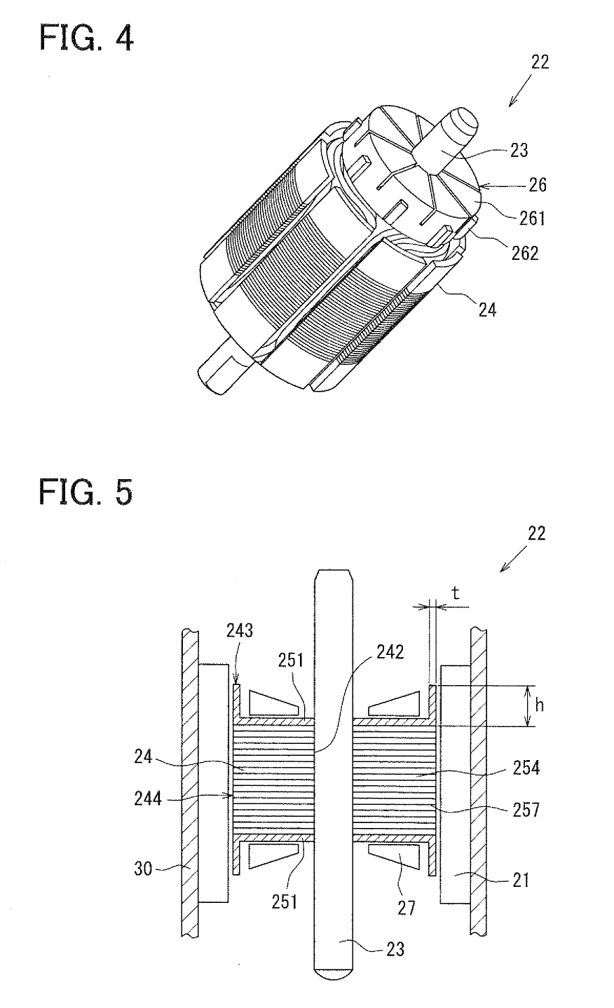

Next, a structure of the armature 22 is described in detail. FIG. 2 shows a perspective view showing substantially only the laminated core 24. FIG. 3 shows a perspective view showing a condition where the laminated core 24 is wound with the coil 27. FIG. 4 shows a perspective view showing a condition where the laminated core 24, which is attached with the commutator 26, is wound with the coil 27.

As shown in FIG. 2, the laminated core 24 is configured by laminating the multiple magnetic plates 25 in the rotation axis direction. Among the multiple magnetic plates 25, an end magnetic plate 251, which is provided at either end in the rotation axis direction of the laminated core 24 has a collar 252 formed at the radially outer side. The collar extends in the rotation axis direction so as to face the pole faces of the permanent magnets 21. Collars 252 of the end magnetic plate 251 provided at the side of the commutator 26, i.e., at the upper side in FIG. 2 extend toward the commutator 26. Other collars 252 of the end magnetic plate 251 provided at the side of the pump portion 10, i.e., at the lower side in FIG. 2 extend toward the pump portion 10.

As shown in FIG. 2, multiple recesses 246 are formed in each of the magnetic plates 25, and the magnetic plates 25 are stacked one another such that the respective recesses 246 are aligned, thereby multiple slots 241 extending in the rotation axis direction are formed in the laminated core 24.

In addition, as shown in FIG. 2, through holes 242 are formed in each of the magnetic plates 25 to penetrate each of the magnetic plates 25 in the rotation axis direction. The through holes 242 are press-inserted with the shaft 23.

The insulating layer 257, which is, for example, a thin film layer, is filmily formed as a coating on at least one of the magnetic plates 25 adjacent to each other. Thus, the insulating layer 257 is provided between the magnetic plates 25 adjacent to each other. The insulating layer 257 may filmily formed on one of the magnetic plates 25 adjacent to each other.

In the present embodiment, the coil 27 is wound in the slots 241 in distributed winding in the armature 22 shown in FIG. 3. In an actual structure, the coil 27 is wound in the slots 241, after the commutator 26 is attached to the shaft 23. As shown in FIG. 4, after the coil 27 is wound in the slots 241, a leading end and a trailing end of the coil 27 are connected to terminals 262 of the commutator 26 in order to produce electric conduction to the segments 261 of the commutator 26.

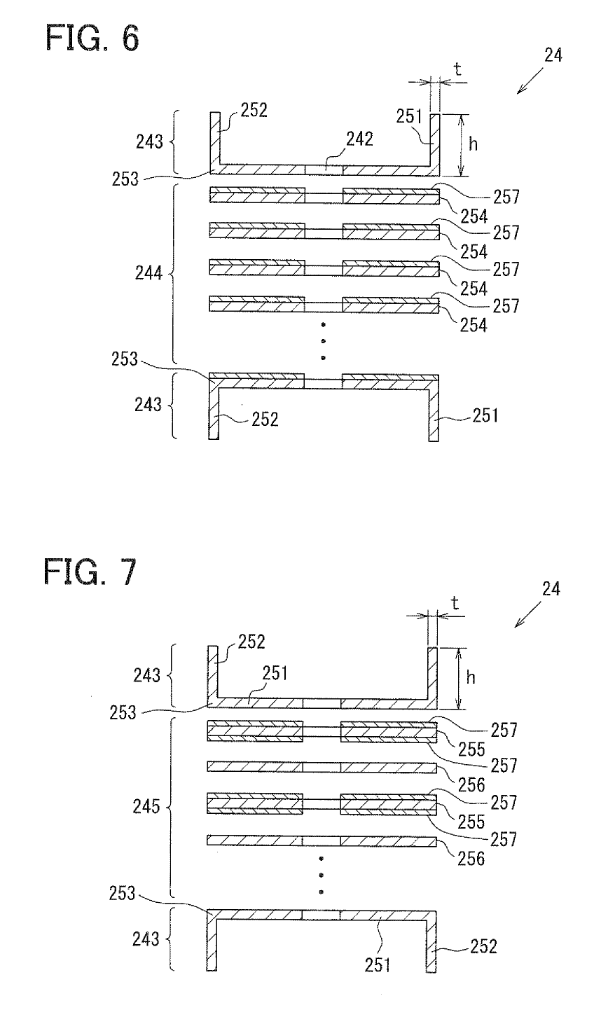

Next, the structure of the laminated core 24 is described in more detail. FIG. 5 is a sectional view schematically showing the armature 22. FIG. 6 is a sectional view showing a condition where the laminated core 24 is exploded.

As shown in FIG. 5, the laminated core 24 is configured by end laminated portions 243 and an intermediate laminated portion 244. Each of the end laminated portions 243 is configured by the end magnetic plate 251 as described before. The intermediate laminated portion 244 is configured by intermediate magnetic plates 254 interposed between the end magnetic plates 251 provided at both ends in the rotation axis direction.

As shown in FIG. 6, each of the intermediate magnetic plates 254 is formed in an approximate disk shape by press forming or the like. The intermediate laminated portion 244 is configured by laminating the intermediate magnetic plates 254, each magnetic plate having the insulating layer 257 filmily formed on only a surface at one end side in the rotation axis direction. Thus, a thickness of a layer of an insulating region can be significantly decreased compared with an intermediate magnetic portion configured by laminating magnetic plates, each of which has insulating layers filmily formed on surfaces at both end sides in the rotation axis direction. As the thickness of the layer of the insulating region is decreased, magnetic flux more easily flows in the rotation axis direction. Since the thickness of the layer of the insulating region can be decreased to the utmost, magnetic flux flowing in the intermediate magnetic plate 254 easily flows not only in the radial direction but also in the rotation axis direction.

The end magnetic plate 251 is formed by press forming or the like so as to have a portion having a concave shape. Thus, the collar 252 can be easily formed from a single magnetic plate. As shown in FIG. 6, the end magnetic plate 251 does not have the insulating layer 257 filmily formed thereon unlike the intermediate magnetic plate 254.

As shown in FIGS. 5, 6, the end magnetic plate 251 has the thickness t, and the collar 252 has the length h. In the present embodiment, the end magnetic plate 251 and the collar 252 are formed to satisfy the relationship of h/t≦10. Here, as shown in FIG. 5, the length h of the collar 252 corresponds to a distance from an end face of the end magnetic plate 251 at a side of the intermediate magnetic plate 254 adjacent to the end magnetic plate 251 to a tip end of the collar 252 extending in the rotation axis direction.

In the present structure, the end magnetic plate 251 has the collar 252 formed thereon, and the collar faces the pole faces of the permanent magnets 21. Therefore, a large amount of magnetic flux flows in the end magnetic plate 251 by an amount corresponding to the dimension of the collar 252, compared with the magnetic flux in the intermediate magnetic plate 254.

When each of the permanent magnets 21 is formed from a ferrite magnet, a magnetic flux density B0 of the ferrite magnet is about 400 to 480 (mT). In the present structure, a magnetic flux density B1 of magnetic flux received by the end magnetic plate 251 lowers to about 200 to 400 (mT) because of a space existing between the magnet and the end magnetic plate 251.

The end magnetic plate 251 has the collar 252. The collar faces the pole faces of the permanent magnets 21. In the present structure, a root region 253 of the collar 252 is concentrated with magnetic flux received by the collar 252. Accordingly, a magnetic flux density B2 at the root region 253 of the collar 252 is a ratio of h/t times larger than the magnetic flux density B1 received by the collar 252. Specifically, the magnetic flux density B2 at the root region 253 of the collar 252 is about (200 to 400)×h/t (mT).

When the end magnetic plate 251 is formed using typically used, silicon steel sheets, saturated magnetic flux density B3 of the silicon steel sheet is about 1600 to 2000 (mT). When the ratio of h/t exceeds 10, magnetic saturation is induced in the end magnetic plate 251. When magnetic saturation is induced in the end magnetic plate 251, magnetic resistance is increased. Consequently, even though the collar 252 is provided so as to suppress leakage flux from the permanent magnets 21, magnetic flux in the laminated core 24 is restricted from increasing in amount. As a result, torque of the motor portion 20 cannot be increased. The material of the end magnetic plate 251 is, for example, the silicon steel sheet in the present embodiment. Alternatively, the material of the end magnetic plate 251 may be a cold-rolled steel sheet such as SPCC specified by the JIS standard.

In the present embodiment, a relationship between the thickness t of the end magnetic plate 251 and the length h of the collar 252 is specified to be h/t≦10, thereby magnetic saturation in the end magnetic plate 251 can be suppressed, and consequently the amount of magnetic flux in the laminated core 24 can be increased.

In the present embodiment, a magnetic plate, on which no insulating layer 257 is filmily formed, is used for the end magnetic plate 251. That is, the end magnetic plate 251 is free from the no insulating layer 257. Therefore, the magnetic flux in the end magnetic plate 251 can be easily flowed into the intermediate magnetic plate 254 adjacent to the end magnetic plate 251, so that magnetic saturation in the end magnetic plate 251 can be suppressed. As a result, the amount of magnetic flux can be increased in the laminated core 24.

Moreover, in the present embodiment, the relationship between the thickness t of the end magnetic plate 251 and the length h of the collar 252 is specified to be h/t≦10, and furthermore, the magnetic plate, on which no insulating layer 257 is filmily formed, is used for the end magnetic plate 251. Therefore, magnetic saturation can be much suppressed in the end magnetic plate 251 compared with magnetic saturation induced in an end magnetic plate, which is merely specified in thickness t and in length h of the collar 252 to be h/t≦10. Consequently, the amount of magnetic flux in the laminated core 24 can be further increased.

Moreover, in the present embodiment, the electric motor as the motor portion 20 is used for the fuel pump 1. Therefore, pump efficiency can be improved without increasing the size of the fuel pump 1. When it is assumed that pressure of fuel discharged by the fuel pump 1 is P, a discharge amount of fuel is Q, torque of the motor portion 20 is T and the number of rotations of the motor portion 20 is N, pump efficiency is defined by (P×Q)/(T×N). Therefore, the present embodiment may be effective for a case that the fuel pump 1 is installed in a fuel tank being restricted in installation place.

### Second Embodiment

FIG. 7 is an exploded sectional view showing a laminated core according to the second embodiment.

The present embodiment is similar to the first embodiment in that thickness t of the end magnetic plate 251 and length h of a collar 252 is in the relation of h/t≦10, and no insulating layer 257 is filmily formed on the surface of the end magnetic plate 251. As shown in FIG. 7, the present embodiment is different from the first embodiment in a configuration of an intermediate laminated portion 245. Hereinafter, description is made on only the difference from the first embodiment.

The intermediate laminated portion 245 of the present embodiment is not configured by laminating intermediate magnetic plates 254, each of which has the insulating layer 257 filmily formed on only a surface at one end side in a rotation axis direction, unlike the intermediate laminated portion 244 (refer to FIG. 6) in the first embodiment. In the present embodiment, the intermediate laminated portion 245 is formed by alternately laminating first intermediate magnetic plates 255, each of which has the insulating layers 257 on surfaces at both end sides in the rotation axis direction, and second intermediate magnetic plates 256, each of which has no insulating layer 257 filmily formed thereon.

In this way, the first intermediate magnetic plates 255 and the second intermediate magnetic plates 256 are alternately laminated so that the laminated core 24 is formed. Even in the present structure, the thickness of a layer of an insulating region can be decreased to the utmost as in the first embodiment. Thus, magnetic flux can easily flow even in the rotation axis direction of the laminated core 24.

The permanent magnets 21 may be one piece having multiple magnetic poles. The collar 252 may be provided to at least one of the end magnetic plates 251.

The structure described in the above embodiments may be applied to a method for manufacturing the laminated core by forming a collar at an outer circumferential side of each of end magnetic plates disposed at the most distant ends in the rotation axis direction, and by laminating the magnetic plates, in which the insulating layer is filmily formed on at least one of the magnetic plates adjacent to each other in an axial direction. The collar extends in the rotation axis direction so as to face pole faces of the permanent magnets, and the insulating layer is not filmily formed on the end magnetic plate disposed at least one end in the rotation axis direction between the end magnetic plates.

The above structures of the embodiments can be combined as appropriate. Various modifications and alternations may be diversely made to the above embodiments without departing from the spirit of the present invention.

What is claimed is:

1. An electric motor comprising:
a permanent magnet having a plurality of magnetic poles, which is circumferentially different from each other; and
an armature rotatable at a radially inside of the permanent magnet and having a laminated core and a coil, the laminated core including a plurality of magnetic plates, which is laminated in an axial direction so as to interpose an insulating layer for suppressing electrical conduction, the coil being wound on the laminated core,
wherein the plurality of magnetic plates includes end magnetic plates located at most distant ends in a rotation axis direction,
at least one of the end magnetic plates has an outer circumferential side provided with a collar, which extends in the rotation axis direction so as to be opposed to pole faces of the permanent magnet,
the at least one of the end magnetic plates has a thickness t,
the collar has a length h, and
the thickness t and the length h have a relationship of h/t≦10.

2. The electric motor according to claim 1, wherein the permanent magnet is a ferrite magnet.

3. The electric motor according to claim 1,
wherein the end magnetic plates include first and second end magnetic plates,
the first end magnetic plate is located at one end in the rotation axis direction,
the second end magnetic plate is located at an other end in the rotation axis direction,
the first and second end magnetic plates therebetween interpose an intermediate laminated portion, which includes the plurality of magnetic plates, which are laminated, and
each of the plurality of magnetic plates has the insulating layer only on a surface at a side of the one end in the rotation axis direction.

4. The electric motor according to claim 1
wherein the end magnetic plates include first and second end magnetic plates,
the first end magnetic plate is located at one end in the rotation axis direction,
the second end magnetic plate is located at an other end in the rotation axis direction,
the first and second end magnetic plates therebetween interpose an intermediate laminated portion, which includes the plurality of magnetic plates,
the plurality of magnetic plates includes first and second magnetic plates, which are alternately laminated,
each of the first magnetic plates has the insulating layer formed on both surfaces, and
each of the second magnetic plates does not have the insulating layer.

5. The electric motor according to claim 1, wherein the collar is formed by bending a portion at the outer circumferential side of each of the end magnetic plates.

6. The electric motor according to claim 1, wherein each of the end magnetic plates has the outer circumferential side provided with the collar.

7. The electric motor according to claim 1, wherein the collar is radially opposed to the pole faces of the permanent magnet.

8. A fuel pump for drawing fuel from a fuel tank and supplying the fuel into a fuel consumption unit, the fuel pump comprising:
the electric motor according to claim 1; and
a pump portion for pressure-feeding fuel drawn by using rotational driving force of the electric motor.

9. An electric motor comprising:
a permanent magnet having a plurality of magnetic poles, which is circumferentially different from each other; and
an armature rotatable at a radially inside of the permanent magnet and having a laminated core and a coil, the laminated core including a plurality of magnetic plates, which is laminated in an axial direction so as to interpose an insulating layer for suppressing electrical conduction, the coil being wound on the laminated core,
wherein the insulating layer is formed on at least one of two of the magnetic plates, which are adjacent to each other,
the plurality of magnetic plates includes end magnetic plates located at most distant ends in a rotation axis direction,
at least one of the end magnetic plates has an outer circumferential side provided with a collar, which extends in the rotation axis direction so as to be opposed to pole faces of the permanent magnet, and
the insulating layer is not formed on at least one of the end magnetic plates.

10. The electric motor according to claim 9,
wherein the end magnetic plates include first and second end magnetic plates,
the first end magnetic plate is located at one end in the rotation axis direction,
the second end magnetic plate is located at an other end in the rotation axis direction,
the first and second end magnetic plates therebetween interpose an intermediate laminated portion, which includes the plurality of magnetic plates, which are laminated, and
each of the plurality of magnetic plates has the insulating layer only on a surface at a side of the one end in the rotation axis direction.

11. The electric motor according to claim 9,
wherein the end magnetic plates include first and second end magnetic plates,
the first end magnetic plate is located at one end in the rotation axis direction,
the second end magnetic plate is located at an other end in the rotation axis direction,
the first and second end magnetic plates therebetween interpose an intermediate laminated portion, which includes the plurality of magnetic plates,
the plurality of magnetic plates includes first and second magnetic plates, which are alternately laminated,
each of the first magnetic plates has the insulating layer formed on both surfaces, and
each of the second magnetic plates does not have the insulating layer.

12. The electric motor according to claim 9, wherein the collar is formed by bending a portion at the outer circumferential side of each of the end magnetic plates.

13. The electric motor according to claim 9, wherein each of the end magnetic plates has the outer circumferential side provided with the collar.

14. The electric motor according to claim 9, wherein the collar is radially opposed to the pole faces of the permanent magnet.

15. A fuel pump for drawing fuel from a fuel tank and supplying the fuel into a fuel consumption unit, the fuel pump comprising:
the electric motor according to claim 9; and
a pump portion for pressure-feeding fuel drawn by using rotational driving force of the electric motor.

16. An electric motor comprising:
a permanent magnet having a plurality of magnetic poles, which is circumferentially different from each other; and
an armature rotatable at a radially inside of the permanent magnet and having a laminated core and a coil, the laminated core including a plurality of magnetic plates, which is laminated in an axial direction so as to interpose an insulating layer for suppressing electrical conduction, the coil being wound on the laminated core,
wherein the insulating layer is formed on at least one of two of the magnetic plates, which are adjacent to each other,
the plurality of magnetic plates includes end magnetic plates located at most distant ends in a rotation axis direction,
at least one of the end magnetic plates has an outer circumferential side provided with a collar, which extends in the rotation axis direction so as to be opposed to pole faces of the permanent magnet,
the at least one of the end magnetic plates has a thickness t,
the collar has a length h,
the thickness t and the length h have a relationship of h/t≦10, and
the insulating layer is not formed on at least one of the end magnetic plates.

17. The electric motor according to claim 16, wherein the permanent magnet is a ferrite magnet.

18. The electric motor according to claim 16,
wherein the end magnetic plates include first and second end magnetic plates,
the first end magnetic plate is located at one end in the rotation axis direction,
the second end magnetic plate is located at an other end in the rotation axis direction,
the first and second end magnetic plates therebetween interpose an intermediate laminated portion, which includes the plurality of magnetic plates, which are laminated, and
each of the plurality of magnetic plates has the insulating layer only on a surface at a side of the one end in the rotation axis direction.

19. The electric motor according to claim 16,
wherein the end magnetic plates include first and second end magnetic plates,
the first end magnetic plate is located at one end in the rotation axis direction,
the second end magnetic plate is located at an other end in the rotation axis direction,
the first and second end magnetic plates therebetween interpose an intermediate laminated portion, which includes the plurality of magnetic plates,
the plurality of magnetic plates includes first and second magnetic plates, which are alternately laminated,
each of the first magnetic plates has the insulating layer formed on both surfaces, and
each of the second magnetic plates does not have the insulating layer.

20. The electric motor according to claim 16, wherein the collar is formed by bending a portion at the outer circumferential side of each of the end magnetic plates.

21. The electric motor according to claim 16, wherein each of the end magnetic plates has the outer circumferential side provided with the collar.

22. The electric motor according to claim 16, wherein the collar is radially opposed to the pole faces of the permanent magnet.

23. A fuel pump for drawing fuel from a fuel tank and supplying the fuel into a fuel consumption unit, the fuel pump comprising:
the electric motor according to claim 16; and
a pump portion for pressure-feeding fuel drawn by using rotational driving force of the electric motor.
